(19) United States
(12) Patent Application Publication
(10) Pub. No.: US 2025/0360916 A1
(43) Pub. Date: Nov. 27, 2025

(54) VEHICLE CONTROL APPARATUS, VEHICLE CONTROL METHOD, AND NON-TRANSITORY COMPUTER-READABLE MEDIUM

(71) Applicant: NEC Corporation, Minato-ku, Tokyo (JP)

(72) Inventors: Takayuki SUZUKI, Tokyo (JP); Takahiro SHIROSHIMA, Tokyo (JP); Hiroshi YOSHIDA, Tokyo (JP)

(73) Assignee: NEC Corporation, Minato-ku, Tokyo (JP)

(21) Appl. No.: 18/872,314

(22) PCT Filed: Jul. 15, 2022
(86) PCT No.: PCT/JP2022/027850

§ 371 Date: Dec. 6, 2024

(51) Int. Cl. B60W 30/06; B60W 10/20

(52) U.S. Cl. CPC B60W 30/06; B60W 10/20; B60W 2540/18

(57) ABSTRACT

A vehicle control apparatus includes: a path generation unit that generates a first path for moving from a first point to a target point; and a determination unit that determines whether or not a vehicle can be considered to have reached a multi-point turning point at a second point in a case where the first path includes a second path to the multi-point turning point and a third path from the multi-point turning point to the target point, in which in a case where it is determined that the vehicle is considered to have reached the multi-point turning point at the second point, the control unit controls a driving unit such that the vehicle travels to a position on the third path, the position being away from the second point by a second distance longer than a first distance between the first point and the multi-point turning point.

### DESCRIPTION

### Technical Field

The present disclosure relates to a vehicle control apparatus, a vehicle control method, and a non-transitory computer-readable medium.

### Background Art

Automated traveling of a vehicle moving by a steering operation is implemented by a vehicle control apparatus performing recognition of a surrounding environment of the vehicle using a sensor, planning of a path to a target point, and path tracking along the planned path. In a case where the vehicle cannot be moved so as to be in a target orientation at the target point only with forward movement along a circular track and a straight path, the vehicle control apparatus generates a path for moving the vehicle backward to perform multi-point turning.

Patent Literature 1 discloses a configuration of a parking assistance apparatus that assists a parking operation involving a multi-point turning operation in a case where movement to a target parking position cannot be made with one reversing movement.

### CITATION LIST

### Patent Literature

Patent Literature 1: Japanese Unexamined Patent Application Publication No. 2003-237511

### SUMMARY OF INVENTION

### Technical Problem

In the case of using the parking assistance apparatus of Patent Literature 1, in a case where a distance from the current position to a multi-point turning point at which the multi-point turning is performed is short, the amount of change in a steering angle is small even in a case where the vehicle has moved to the multi-point turning point. In this case, even if the vehicle moves backward to the multi-point turning point and then moves forward from the multi-point turning point to a target position, the vehicle may trace substantially the same track. In this case, a path for moving to the multi-point turning point again is generated at a point where the backward movement is started, and thus, movement on the same path is repeated, which is problematic.

An object of the present disclosure is to provide a vehicle control apparatus, a vehicle, a vehicle control method, and a non-transitory computer-readable medium that can prevent repetition of movement on the same path in a case where a path including multi-point turning is planned.

### Solution to Problem

A vehicle control apparatus according to a first aspect of the present disclosure includes: a path generation unit configured to generate a first path for a vehicle to move from a first point where the vehicle is present to a target point so as to be in a target orientation at the target point; a control unit configured to control a driving unit such that the vehicle moves along the first path; and a determination unit configured to determine whether or not the vehicle is considered to have reached a multi-point turning point at a second point on a second path in a case where the first path includes the second path from the first point to the multi-point turning point at which multi-point turning of the vehicle is performed and a third path from the multi-point turning point to the target point, in which in a case where it is determined that the vehicle is considered to have reached the multi-point turning point at the second point, the control unit controls the driving unit such that the vehicle travels to a relay point on the third path, the relay point being present at a position away from the second point by a second distance longer than a first distance between the first point and the multi-point turning point.

A vehicle control method according to a second aspect of the present disclosure includes: generating a first path for a vehicle to move from a first point where the vehicle is present to a target point so as to be in a target orientation at the target point; determining whether or not the vehicle has reached a multi-point turning point or whether or not the multi-point turning point is reachable by the vehicle in a case where the path includes the multi-point turning point at which multi-point turning of the vehicle is performed; and generating a second path for moving the vehicle to a position away from a second point by a second distance longer than a first distance between the first point and the second point in a case where it is determined that the vehicle has reached the multi-point turning point or the multi-point turning point is not reachable by the vehicle at the second point.

A program according to a third aspect of the present disclosure causes a computer to execute: generating a first path for a vehicle to move from a first point where the vehicle is present to a target point so as to be in a target orientation at the target point; determining whether or not the vehicle has reached a multi-point turning point or whether or not the multi-point turning point is reachable by the vehicle in a case where the path includes the multi-point turning point at which multi-point turning of the vehicle is performed; and generating a second path for moving the vehicle to a position away from a second point by a second distance longer than a first distance between the first point and the second point in a case where it is determined that the vehicle has reached the multi-point turning point or the multi-point turning point is not reachable by the vehicle at the second point.

### Advantageous Effects of Invention

According to the present disclosure, it is possible to provide a vehicle control apparatus, a vehicle control method, and a non-transitory computer- readable medium that can prevent repetition of movement on the same path in a case where a path including multi-point turning is planned.

### BRIEF DESCRIPTION OF DRAWINGS

FIG. 1 is a configuration diagram of a vehicle control apparatus according to a first example embodiment.

FIG. 2 is a flowchart of vehicle control processing according to the first example embodiment.

FIG. 3 is a configuration diagram of a vehicle control apparatus according to a second example embodiment.

FIG. 4 is a diagram for describing a multi-point turning point according to the second example embodiment.

FIG. 5 is a diagram for describing an operation mode of a vehicle according to the second example embodiment.

FIG. 6 is a flowchart of vehicle control processing according to the second example embodiment.

FIG. 7 is a flowchart of the vehicle control processing according to the second example embodiment.

FIG. 8 is a flowchart of processing of selecting a target according to the second example embodiment.

FIG. 9 is a flowchart of processing of determining whether or not the multi-point turning point is reachable by the vehicle according to the second example embodiment.

FIG. 10 is a configuration diagram of the vehicle control apparatus according to each example embodiment.

### EXAMPLE EMBODIMENT

### First Example Embodiment

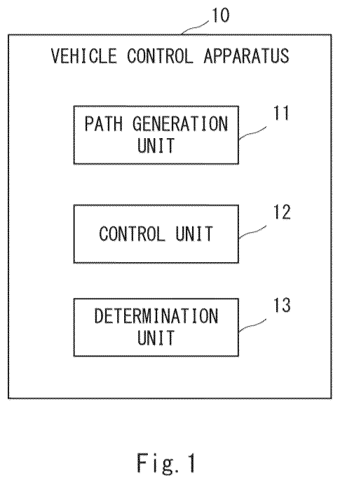

Hereinafter, example embodiments of the present disclosure are described with reference to the drawings. A configuration example of a vehicle control apparatus 10 according to a first example embodiment will be described with reference to FIG. 1. The vehicle control apparatus 10 may be a computer apparatus that operates by a processor executing a program stored in a memory. The vehicle control apparatus 10 may be mounted on a vehicle and control movement of the vehicle. Alternatively, the vehicle control apparatus 10 may remotely operate or remotely control the vehicle via a network.

The vehicle is a vehicle that moves by a steering operation. The vehicle determines a traveling direction according to a turning radius determined based on a steering angle with respect to a front direction of the vehicle. In addition, it is assumed that rotation of a steering wheel of the vehicle is not performed in a stopped state. Not performing the rotation of the steering wheel of the vehicle in the stopped state may be rephrased as not changing the steering angle in the stopped state. The rotation of the steering wheel in the stopped state is referred to as so-called stationary steering, and it is assumed that the vehicle described in the example embodiment does not perform the stationary steering.

The vehicle may be, for example, an automobile, a forklift, or a mobile robot.

The vehicle control apparatus 10 includes a path generation unit 11, a control unit 12, and a determination unit 13. The path generation unit 11, the control unit 12, and the determination unit 13 may be software or modules whose processing is executed by a processor executing a program stored in a memory. Alternatively, the path generation unit 11, the control unit 12, and the determination unit 13 may be hardware such as a circuit or a chip.

The path generation unit 11 generates a first path for the vehicle to move from a first point where the vehicle is present to a target point so as to be in a target orientation at the target point. The first point may be, for example, a position where the vehicle is present at a timing when the path generation unit 11 generates the path. The orientation may be, for example, a direction in which a front side of the vehicle is directed with respect to a predetermined reference direction. That is, the orientation may be an angle formed by a straight line along the predetermined reference direction and a straight line along the front direction of the vehicle. The target orientation is an orientation at the target point.

The path generation unit 11 generates a vehicle movement path to the target point before the vehicle starts to move, and further updates the vehicle movement path to the target point even during movement of the vehicle. The path generation unit 11 may periodically update the vehicle movement path during the movement of the vehicle, or may update the vehicle movement path at an arbitrary timing in a case where an instruction to update the movement path is received. Alternatively, the path generation unit 11 may update the vehicle movement path every time the vehicle moves by a predetermined distance. Alternatively, the path generation unit 11 may update the vehicle movement path in a case where, for example, there is an obstacle in an image or the like obtained by capturing an area in the traveling direction of the vehicle and it is necessary to avoid the obstacle.

The control unit 12 controls a driving unit such that the vehicle moves along the first path generated by the path generation unit 11. The driving unit may be, for example, a system for controlling driving wheels, and controls a rotational speed of the driving wheels, an angle of the driving wheels determined by a steering operation, and the like. The control unit 12 controls the movement of the vehicle by transmitting information regarding the movement of the vehicle, such as a speed, a movement direction, a turning direction, or a turning radius of the vehicle, to the driving unit.

In a case where the first path includes a multi-point turning point, the determination unit 13 determines whether or not the vehicle can be considered to have reached the multi-point turning point. The multi-point turning point may be, for example, a point where the traveling direction of the vehicle is changed from a forward direction to a backward direction, or a point where the traveling direction of the vehicle is changed from the backward direction to the forward direction. The multi-point turning point may be provided in a case where the vehicle cannot move so as to be in the target orientation at the target point only with forward movement of the vehicle involving a steering wheel rotation operation or backward movement of the vehicle involving a steering wheel rotation operation.

The first path may include a second path from the first point to the multi-point turning point at which multi-point turning of the vehicle is performed, and a third path from the multi-point turning point to the target point. In this case, the determination unit 13 determines whether or not the vehicle can be considered to have reached the multi-point turning point at a second point on the second path.

The second point may be a point where the vehicle has moved from the first point to the multi-point turning point by a predetermined distance. A case where the vehicle can be considered to have reached the multi-point turning point may include, for example, a case where the vehicle has reached the multi-point turning point and a case where the vehicle is present in a predetermined area. The predetermined area may be, for example, an area centered on the multi-point turning point and specified by a circle having a determined radius. Alternatively, the predetermined area may be an area centered on the multi-point turning point and specified by a predetermined area. The predetermined area may be indicated using coordinates of a predetermined coordinate system.

Further, a case where the vehicle can be considered to have reached the multi-point turning point may include a case where it is determined that the multi-point turning point is not reachable by the vehicle.

In a case where it is determined that the vehicle is considered to have reached the multi-point turning point at the second point, the control unit 12 controls the driving unit to move to an arbitrary position on the third path. The arbitrary position on the third path is a position away from the multi-point turning point by a second distance longer than a first distance between the first point and the multi-point turning point. The arbitrary position on the third path can also be regarded as a relay point. That is, the arbitrary position on the third path may be rephrased as the relay point.

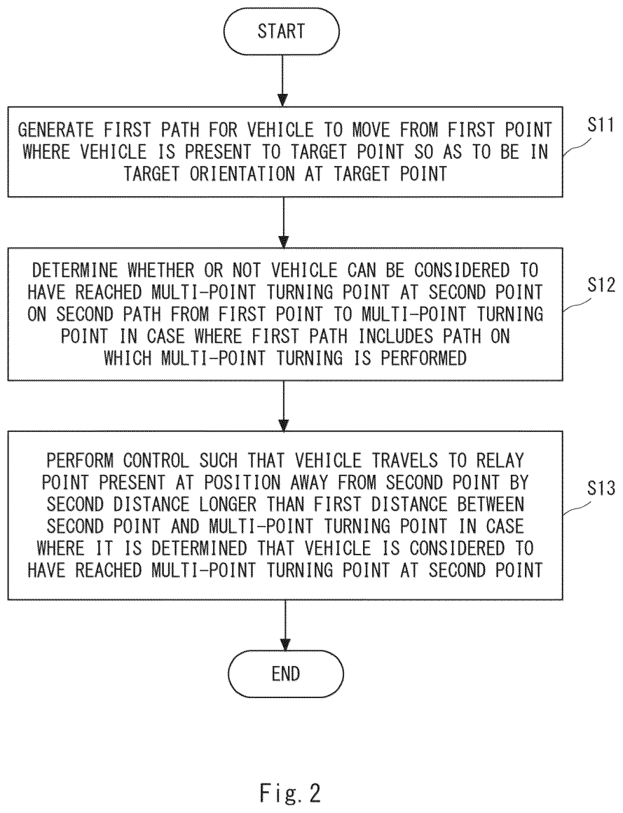

Next, a flow of vehicle control processing executed in the vehicle control apparatus 10 will be described with reference to FIG. 2. First, the path generation unit 11 generates the first path for the vehicle to move from the first point where the vehicle is present to the target point so as to be in the target orientation at the target point (S11). Next, the control unit 12 controls the driving unit of the vehicle such that the vehicle moves along the first path (S12).

Next, the determination unit 13 determines whether or not the first path includes the second path from the first point to the multi-point turning point at which the multi-point turning of the vehicle is performed, and the third path from the multi-point turning point to the target point (S13). Next, the determination unit 13 determines whether or not the vehicle can be considered to have reached the multi-point turning point at the second point on the second path (S14). Next, in a case where it is determined that the vehicle is considered to have reached the multi-point turning point at the second point, the control unit 12 controls the driving unit such that the vehicle travels to the relay point on the third path (S15). The relay point is a position away from the multi-point turning point by the second distance longer than the first distance between the first point and the multi-point turning point.

As described above, in a case where the vehicle is considered to have reached the multi-point turning point, the vehicle control apparatus 10 according to the first example embodiment moves the vehicle from the multi-point turning point to a position more distant than the first point where the vehicle was positioned at timing when the path to the target point was generated. As a result, the vehicle control apparatus 10 can update the path to the target point before reaching the first point, and can prevent the vehicle from moving on a path returning to the multi-point turning point again.

### Second Example Embodiment

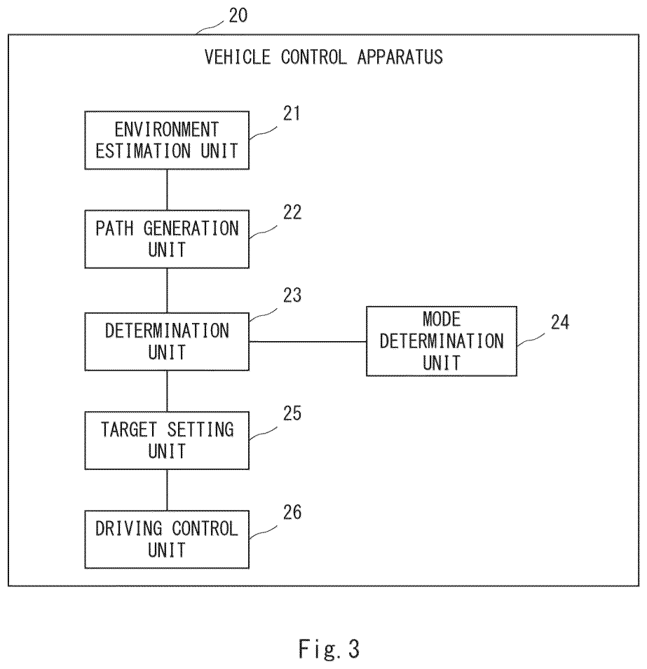

Next, a configuration example of a vehicle control apparatus 20 according to a second example embodiment will be described with reference to FIG. 3. The vehicle control apparatus 20 includes an environment estimation unit 21, a path generation unit 22, a determination unit 23, a mode determination unit 24, a target setting unit 25, and a driving control unit 26. The path generation unit 22 corresponds to the path generation unit 11 in the vehicle control apparatus 10 of FIG. 1. The determination unit 23 corresponds to the determination unit 13 in the vehicle control apparatus 10 of FIG. 1. The driving control unit 26 corresponds to the control unit 12 in the vehicle control apparatus 10 of FIG. 1. Each component included in the vehicle control apparatus 20 may be software or a module whose processing is executed by a processor executing a program stored in a memory. Alternatively, each component included in the vehicle control apparatus 20 may be hardware such as a circuit or a chip.

The environment estimation unit 21 estimates a position and an orientation of a vehicle and generates an environment map indicating a surrounding environment of the vehicle. The environment estimation unit 21 estimates the position and the orientation of the vehicle by using, for example, a plurality of images captured by an imaging device mounted on the vehicle. The environment estimation unit 21 may estimate the position and the orientation of the vehicle by executing visual simultaneous localization and mapping (VSLAM). For example, in the VSLAM, the same point included in a plurality of videos is recognized as a feature point in the plurality of images (still images) constituting the videos, and the position and the orientation of the vehicle on which the imaging device is mounted are estimated from a difference in feature point between the images.

The environment map is a map indicating the surrounding environment of the vehicle by using three-dimensional information. The surrounding environment of the vehicle may include, for example, an obstacle around the vehicle. If indoors, the obstacle may be a shelf, a desk, a wall, or the like, and if outdoors, the obstacle may be a building or the like. The three-dimensional information may be paraphrased as 3D information, three-dimensional coordinates, or the like. The environment map may be generated by executing structure from motion (SfM) using the plurality of images captured by the imaging device. The SfM calculates all feature points of a series of already acquired two-dimensional images (or frames), and estimates matching feature points from a plurality of temporally successive images. Further, the SfM accurately estimates a three-dimensional position or orientation of a camera that has captured each frame based on a difference in position on a two-dimensional plane between the frames in which each feature point appears. Alternatively, the environment map may be generated by executing the VSLAM.

The path generation unit 22 generates a path for the vehicle to move from the current point where the vehicle is present to a target point so as to be in a target orientation at the target point. The path generation unit 22 may update the generated path periodically or at an arbitrary timing. The path generated by the path generation unit 22 may include a multi-point turning point.

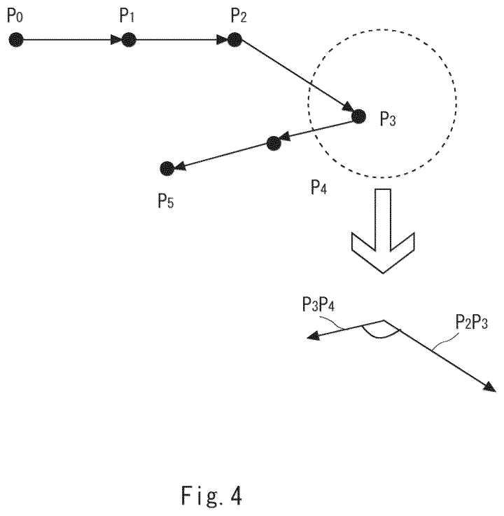

The determination unit 23 determines whether or not the path generated by the path generation unit 22 includes the multi-point turning point. Here, the multi-point turning point will be described with reference to FIG. 4. A point P₀ is the current point, and a point P₅ is the target point. P₁ to P₄ are relay points present on the path. A path between the points on the path is defined as a path PₙPₙ₊₁. In a case where n=0 to 4, for example, a path P₀P₁ in a case where n=0 is a path from P₀ to P₁. Here, in a case where an angle between a path Pₙ₋₁Pₙ and the path PₙPₙ₊₁ is larger than 90 degrees, a point Pₙ is defined as the multi-point turning point. The angle formed by the path Pₙ₋₁Pₙ and the path PₙPₙ₊₁ may be, for example, the smaller angle of angles formed at a point Pₙ₋₁ and the point Pₙ that overlap each other by translating the point Pₙ₋₁ in the path Pₙ₋₁Pₙ to the point Pₙ in the path PₙP_{n+1.} In the example of FIG. 4, it is illustrated that an angle formed by a path P₂P₃ and a path P₃P₄ is larger than 90 degrees. Therefore, a point P₃ becomes the multi-point turning point.

The determination unit 23 sets the relay points in the path generated by the path generation unit 22, and determines whether or not the multi-point turning point is included by determining whether or not an angle formed by paths between the relay points is larger than 90 degrees. Furthermore, the determination unit 23 determines whether or not the position of the vehicle can be considered to have reached the multi-point turning point. A case where the position of the vehicle is considered to have reached the multi-point turning point may include, for example, a case where the vehicle is present in a predetermined area and a case where it is determined that the multi-point turning point is not reachable by the vehicle.

The predetermined area may be, for example, an area indicated by a circle centered on the multi-point turning point. A radius of the circle centered on the multi-point turning point is defined as a traversing determination distance. In a case where the vehicle is present inside the circle centered on the multi-point turning point and having the radius equal to the traversing determination distance, the determination unit 23 may determine that the vehicle can be considered to have reached the multi-point turning point. That is, in a case where a distance between the vehicle and the multi-point turning point is shorter than the traversing determination distance, the determination unit 23 may determine that the vehicle can be considered to have reached the multi-point turning point.

The traversing determination distance may be a changeable distance. For example, the longer the traversing determination distance, the larger the area where the vehicle can be considered to have reached the multi-point turning point. On the other hand, the shorter the traversing determination distance, the smaller the area where the vehicle can be considered to have reached the multi-point turning point. A state in which the traversing determination distance is longer than a predetermined distance is defined as a recovery mode, and a state in which the traversing determination distance is shorter than the predetermined distance is defined as a normal mode.

In addition, the determination unit 23 may determine that the multi-point turning point is not reachable by the vehicle in a case where a steering wheel cannot be rotated to an angle toward the multi-point turning point before the vehicle reaches the multi-point turning point.

The mode determination unit 24 determines whether to set an operation mode of the vehicle to the recovery mode or the normal mode. For example, the mode determination unit 24 may change the operation mode of the vehicle to the recovery mode in a case where the vehicle operating in the normal mode can be considered to have reached the multi-point turning point. As the operation mode of the vehicle is changed to the recovery mode, the longer the traversing determination distance, and the larger the area where the vehicle can be considered to have reached the multi-point turning point.

Here, an influence of the traversing determination distance on the operation of the vehicle will be described. In a case where the vehicle travels toward the target point after performing a multi-point turning operation, a path including the multi-point turning point regarded as being reached may be generated again. Even in such a case, in a case where the vehicle moves in an area where the vehicle can be considered to have reached the multi-point turning point, the vehicle is considered to have reached the multi-point turning point. Therefore, the vehicle does not travel to the multi-point turning point but to the target point. As a result, the vehicle does not return to the multi-point turning point until the vehicle moves from the multi-point turning point to the outside of the area where the vehicle can be considered to have reached the multi-point turning point. As a result, the vehicle can move to a position sufficiently away from the multi-point turning point.

In addition, the mode determination unit 24 may change the operation mode of the vehicle from the recovery mode to the normal mode in a case where the vehicle satisfies a predetermined condition. The predetermined condition may be, for example, that the vehicle has moved a certain distance after the operation mode of the vehicle is changed to the recovery mode. The certain distance may be, for example, a value obtained by multiplying a time for moving the steering wheel from a right maximum angle of the steering wheel in a case where turning to the right to a left maximum angle of the steering wheel in a case where turning to the left by a minimum speed of the vehicle. The time for moving the steering wheel from the right maximum angle of the steering in a case where turning to the right to the left maximum angle of the steering wheel in a case where turning to the left and the minimum speed of the vehicle may be determined in advance as performance values of the vehicle. Alternatively, the minimum speed of the vehicle may be a predetermined minimum speed in an area where the vehicle travels.

In some cases, path update may be performed during movement of the vehicle, and the updated path may include the multi-point turning point. In such a case, the operation mode of the vehicle may be changed from the recovery mode to the normal mode in a case where the vehicle moves outside the area where the vehicle can be considered to have reached the multi-point turning point, the area being centered on the multi-point turning point. This is because, in a case where the vehicle is at a location away from the multi-point turning point by a distance equal to or longer than the traversing determination distance, the current point and the multi-point turning point are sufficiently separated from each other, and thus, it is considered that there is a low possibility that movement efficiency of the vehicle deteriorates due to minor movement of the vehicle in the vicinity of the multi-point turning point.

The predetermined condition used in a case where the operation mode of the vehicle is changed from the recovery mode to the normal mode may be referred to as an exit condition from the recovery mode.

The target setting unit 25 determines, as a target, an arbitrary point on the path generated by the path generation unit 22. For example, in a case where the vehicle is considered to have reached the multi-point turning point, the target setting unit 25 determines an arbitrary point on the path to the target point as the target. The target corresponds to the relay point described in FIG. 4. The driving control unit 26 controls a driving unit so as to bring the vehicle closer to the target.

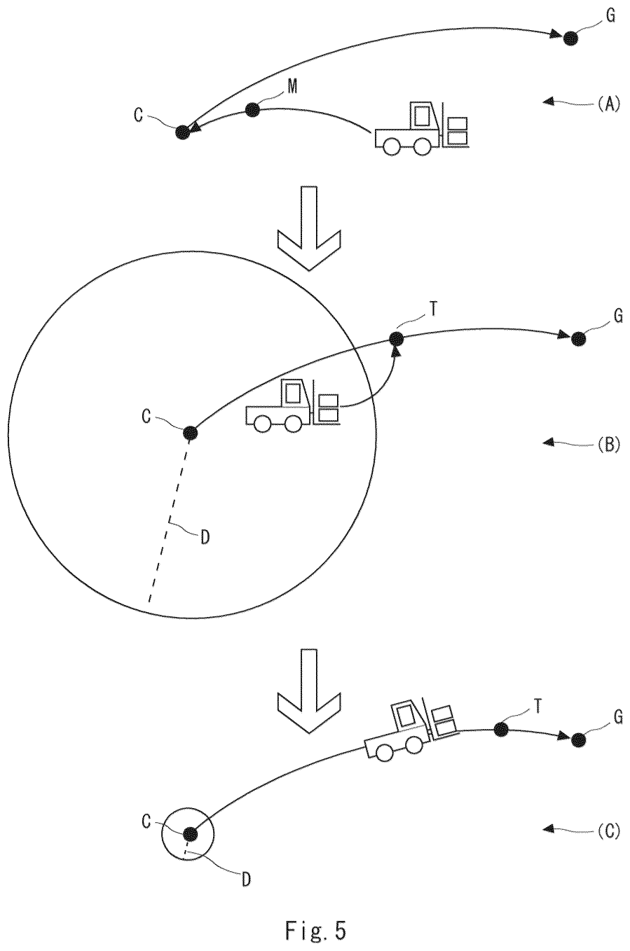

Here, the operation mode of the vehicle will be described with reference to FIG. 5. FIG. 5 illustrates an example in which the vehicle travels on the path including the multi-point turning point. The path including the multi-point turning point is a path including a multi-point turning point C and a target point G.

(A) of FIG. 5 illustrates a state in which the vehicle travels to the multi-point turning point C via a relay point M. In (A) of FIG. 5, the vehicle is operated in the normal mode, and the traversing determination distance is set to 0. The traversing determination distance is not limited to 0, and a distance shorter than the predetermined distance may be set as the traversing determination distance. The determination unit 23 determines whether or not the vehicle can be considered to have reached the multi-point turning point C at the relay point M.

(B) of FIG. 5 illustrates a state where the determination unit 23 determines that the vehicle can be considered to have reached the multi-point turning point C. Specifically, the determination unit 23 determines that the vehicle can be considered to have reached the multi-point turning point C because the vehicle cannot reach the multi-point turning point C. In a case where the determination unit 23 determines that the vehicle is considered to have reached the multi-point turning point C, the mode determination unit 24 changes the operation mode of the vehicle to the recovery mode. At this time, the mode determination unit 24 extends the traversing determination distance to a distance D. A circle centered on the multi-point turning point C and having a radius D in (B) of FIG. 5 indicates an area where the vehicle can be considered to have reached the multi-point turning point C. In a case where the determination unit 23 determines that the vehicle is configured to have reached the multi-point turning point C, the target setting unit 25 sets a target T between the multi-point turning point C and the target point G. The target T may be set inside or outside the circle centered on the multi-point turning point C and having the radius D.

(C) of FIG. 5 illustrates that the operation mode of the vehicle is changed from the recovery mode to the normal mode in a case where the target T approaches the target point G and the vehicle satisfies the predetermined condition. The traversing determination distance in a case where a change from the recovery mode to the normal mode is made may be set to 0 similarly to (A) of FIG. 5, or may be set to the distance D sufficiently shorter than the traversing determination distance D in the recovery mode.

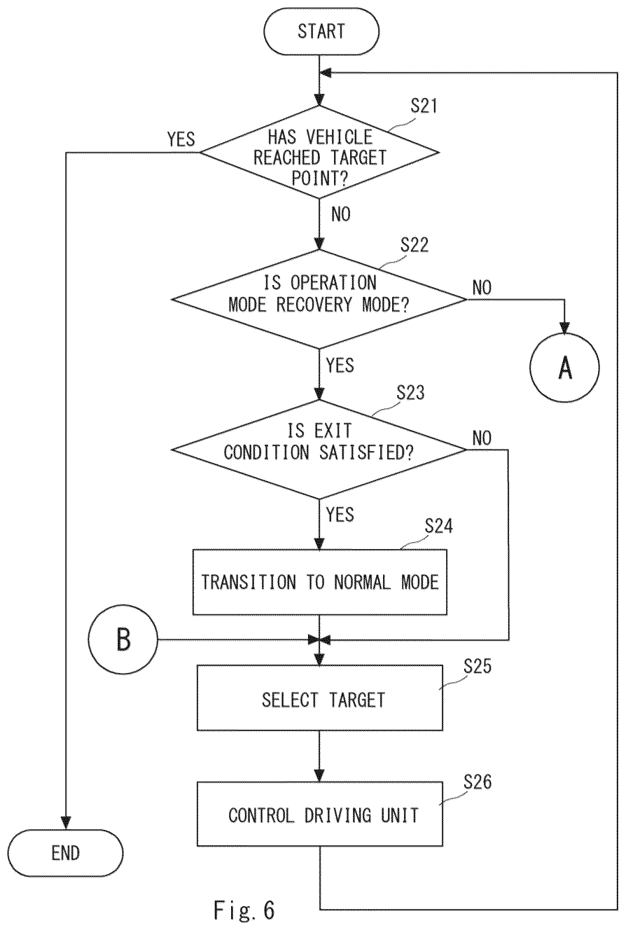

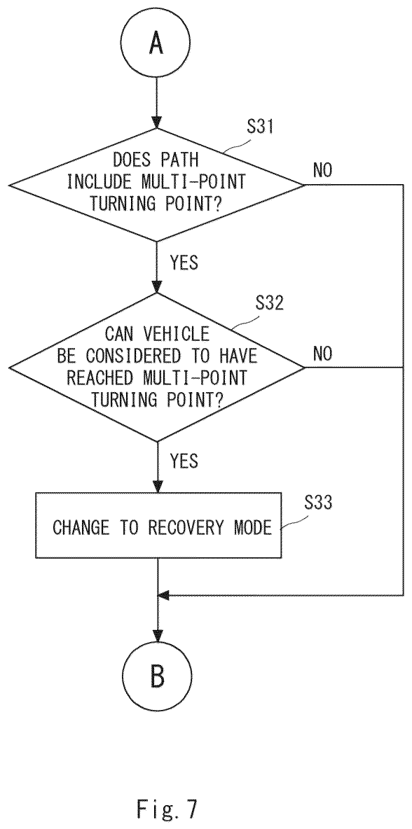

Next, a flow of vehicle control processing in the vehicle control apparatus 20 according to the second example embodiment will be described with reference to FIGS. 6 and 7. First, the determination unit 23 determines whether or not the vehicle has reached the target point (S21). In a case where the determination unit 23 determines that the vehicle has reached the target point, the processing ends. In a case where it is determined that the vehicle has not reached the target point, the determination unit 23 determines whether or not the operation mode of the vehicle is the recovery mode (S22). In a case where the determination unit 23 determines that the operation mode of the vehicle is the recovery mode, the mode determination unit 24 determines whether or not the vehicle satisfies the exit condition from the recovery mode (S23). In a case where it is determined that the exit condition is satisfied, the mode determination unit 24 changes the operation mode of the vehicle from the recovery mode to the normal mode (S24). Next, the target setting unit 25 selects, as the target, a point between the multi-point turning point and the target point (S25). Next, the driving control unit 26 controls the driving unit so as to bring the vehicle closer to the target (S26). After the processing of step S26 is executed, the processing of step S21 and subsequent steps is repeated.

In a case where the mode determination unit 24 determines in step S23 that the vehicle does not satisfy the exit condition from the recovery mode, the processing of step S25 is executed without executing the processing of step S24.

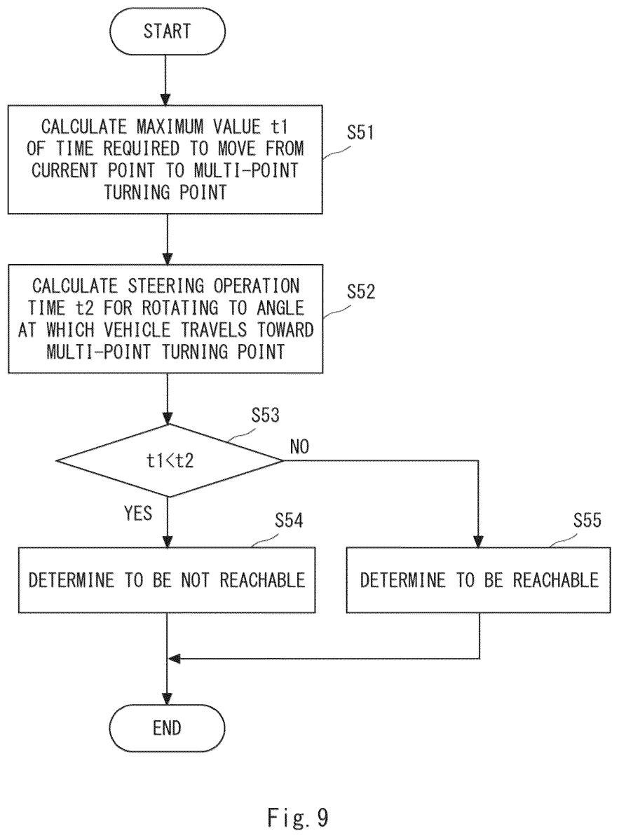

In a case where the determination unit 23 determines in step S22 that the operation mode is not the recovery mode, the processing proceeds to FIG. 7, and it is determined whether or not the path to the target point is a path including the multi-point turning point (S31). In a case where the determination unit 23 determines that the path to the target point is a path including the multi-point turning point, the mode determination unit 24 determines whether or not the vehicle can be considered to have reached the multi-point turning point at the current point of the vehicle (S32). Details of step S32 are described below with reference to FIG. 9.

In a case where it is determined that the vehicle can be considered to have reached the multi-point turning point at the current point, the mode determination unit 24 changes the vehicle mode to the recovery mode and proceeds to the processing of step S25 (S33). In a case where the determination unit 23 determines in step S31 that the path to the target point is a path that does not include the multi-point turning point, the processing proceeds to step S25 without changing the operation mode. Alternatively, in a case where the mode determination unit 24 determines in step S32 that the vehicle cannot be considered to have reached the multi-point turning point at the current point of the vehicle, the processing proceeds to step S25 without changing the operation mode.

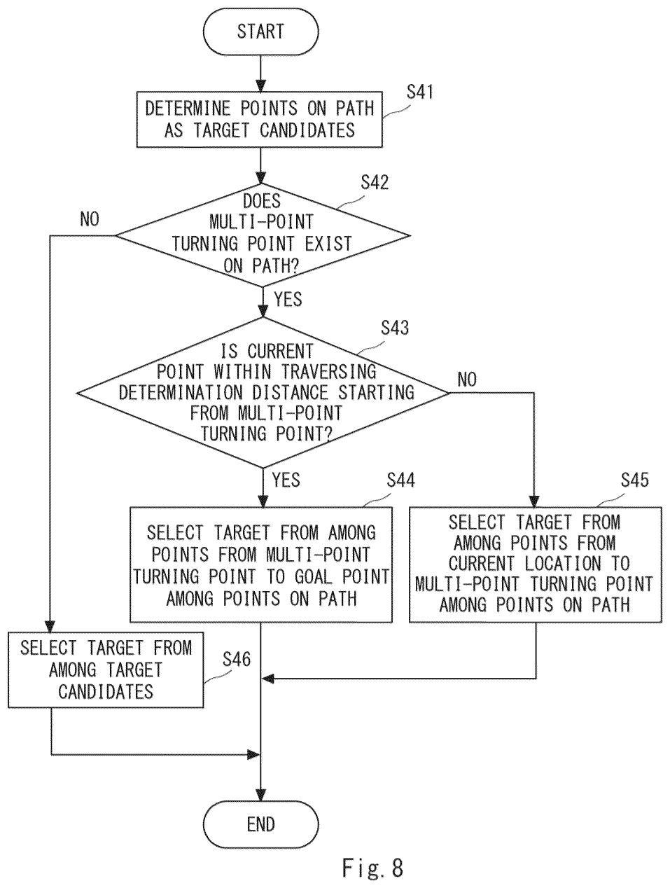

Here, details of the processing of selecting the target in step S25 of FIG. 6 will be described with reference to FIG. 8.

First, the target setting unit 25 determines a plurality of points as target candidates on the path (S41). For example, in a case where the number of points as the target candidates is determined in advance, the target setting unit 25 may determine a plurality of points as the target candidates such that distances between the points as the candidates are equal on the path from the current point to the target point. Alternatively, the target setting unit 25 may determine a distance between points as the target candidates and then determine a plurality of points as the target candidates. Alternatively, the target setting unit 25 may determine a plurality of points as the target candidates so as to increase a distance between the points as the target candidates as approaching the target point on the path from the current point to the target point. Alternatively, the target setting unit 25 may determine a plurality of points as the target candidates so as to decrease a distance between the points as the target candidates as approaching the target point on the path from the current point to the target point.

Next, the target setting unit 25 determines whether or not the multi-point turning point exists in the path from the current point to the target point (S42). In a case where it is determined that the multi-point turning point exists in the path from the current point to the target point, the target setting unit 25 determines whether or not the current point is within the traversing determination distance starting from the multi-point turning point (S43). The current point being within the traversing determination distance starting from the multi-point turning point may mean that the current point is inside the circle centered on the multi-point turning point and having the radius equal to the traversing determination distance.

In a case where it is determined that the current point is within the traversing determination distance starting from the multi-point turning point, the target setting unit 25 selects the target from among the target candidates set between the multi-point turning point and the target point (S44).

In a case where it is determined that the current point is not within the traversing determination distance starting from the multi-point turning point, the target setting unit 25 selects the target from among the target candidates set between the current point and the multi-point turning point (S45).

In a case where it is determined in step S42 that the multi-point turning point does not exist on the path from the current point to the target point, the target setting unit 25 selects the target from among the set target candidates (S46).

In steps S44 to S46, the target setting unit 25 may select, as the target, a candidate closest to the current point from among, for example, possible target candidates. Alternatively, the target setting unit 25 may select the target from among possible target candidates according to a pure pursuit algorithm which is a known path tracking algorithm. Alternatively, the target setting unit 25 may select the target from among possible target candidates according to an arbitrary algorithm.

Next, details of the processing of determining whether or not the multi-point turning point is reachable by the vehicle in step S32 of FIG. 7 will be described with reference to FIG. 9. First, the determination unit 23 calculates a maximum value t1 of a time required to move from the current point to the multi-point turning point (S51). For example, the determination unit 23 may calculate the time t1 by using a minimum speed defined as performance of the vehicle or a predetermined movement speed and a distance from the current point to the multi-point turning point. The distance from the current point to the multi-point turning point may be a distance between the current point and a position away from the multi-point turning point by the traversing determination distance. In other words, the distance from the current point to the multi-point turning point may be a distance between the current point and a point on a circumference of the circle centered on the multi-point turning point and having the radius equal to the traversing determination distance.

Next, the determination unit 23 calculates a steering operation time t2 for rotating to an angle at which the vehicle travels toward the multi-point turning point (S52). In other words, the steering operation time t2 may be a time for rotating the steering wheel to a position of the steering wheel corresponding to an angle at which the vehicle travels toward the multi-point turning point.

Next, the determination unit 23 determines whether or not the time t2 has a value larger than the time t1 (S53). In a case where it is determined that the time t2 is longer than the time t1, the determination unit 23 determines that the vehicle cannot reach the multi-point turning point (S54). In a case where it is determined that the time t2 is shorter than the time t1 or the time t2 and the time t1 are the same as each other, the determination unit 23 determines that the multi-point turning point is reachable by the vehicle (S55).

As described above, the vehicle control apparatus 20 according to the second example embodiment increases the traversing determination distance in a case where the vehicle can be considered to have reached the multi-point turning point. As a result, the vehicle can move to a sufficiently distant position after the multi-point turning, and thus, it is possible to avoid a decrease in movement efficiency due to movement to the multi-point turning point again immediately after the multi-point turning.

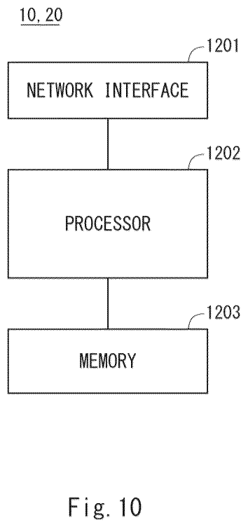

FIG. 10 is a block diagram illustrating a configuration example of the vehicle control apparatus 10 and the vehicle control apparatus 20 (hereinafter, referred to as the vehicle control apparatus 10 or the like) described in the above-described example embodiments. Referring to FIG. 10, the vehicle control apparatus 10 or the like includes a network interface 1201, a processor 1202, and a memory 1203. The network interface 1201 may be used to communicate with network nodes. The network interface 1201 may include, for example, a network interface card (NIC) conforming to IEEE 802.3 series. IEEE represents Institute of Electrical and Electronics Engineers.

The processor 1202 reads and executes software (computer program) from the memory 1203 to execute processing in the information processing apparatus 10 or the like described with reference to the flowcharts in the above-described example embodiments. The processor 1202 may be, for example, a microprocessor, a micro processing unit (MPU), or a central processing unit (CPU). The processor 1202 may include a plurality of processors.

The memory 1203 is implemented by a combination of a volatile memory and a nonvolatile memory. The memory 1203 may include a storage disposed away from the processor 1202. In this case, the processor 1202 may access the memory 1203 through an input/output (I/O) interface (not illustrated).

In the example of FIG. 10, the memory 1203 is used to store a software module group. The processor 1202 can execute the processing of the vehicle control apparatus 10 or the like described in the above-described example embodiments by reading and executing the software module group from the memory 1203.

As described with reference to FIG. 10, each of the processors included in the vehicle control apparatus 10 or the like in the above-described example embodiments executes one or a plurality of programs including a command group for causing a computer to perform the algorithm described with reference to the drawings.

In the above-described example, the program includes a group of instructions (or software codes) for causing a computer to execute one or more functions described in the example embodiments in a case where the program is read by the computer. The program may be stored in a non-transitory computer-readable medium or a tangible storage medium. As an example and not by way of limitation, the computer-readable medium or the tangible storage medium includes a random-access memory (RAM), a read-only memory (ROM), a flash memory, a solid-state drive (SSD) or any other memory technology, a CD-ROM, a digital versatile disc (DVD), a Blu-ray (registered trademark) disc or any other optical disc storage, a magnetic cassette, a magnetic tape, and a magnetic disk storage or any other magnetic storage device. The program may be transmitted on a transitory computer-readable medium or a communication medium. As an example and not by way of limitation, the transitory computer-readable medium or the communication medium includes electrical, optical, acoustic, or other forms of propagated signals.

Note that the technical ideas of the present disclosure are not limited to the above-described example embodiments, and can be appropriately modified without departing from the scope.

### REFERENCE SIGNS LIST

### 10 VEHICLE CONTROL APPARATUS

### 11 PATH GENERATION UNIT

### 12 CONTROL UNIT

### 13 DETERMINATION UNIT

### 20 VEHICLE CONTROL APPARATUS

### 21 ENVIRONMENT ESTIMATION UNIT

### 22 PATH GENERATION UNIT

### 23 DETERMINATION UNIT

### 24 MODE DETERMINATION UNIT

### 25 TARGET SETTING UNIT

### 26 DRIVING CONTROL UNIT

What is claimed is:

1. A vehicle control apparatus comprising:
at least one memory storing instructions; and
at least one processor configured to execute the instructions to;
generate a first path for a vehicle to move from a first point where the vehicle is present to a target point so as to be in a target orientation at the target point;
control a driving unit such that the vehicle moves along the first path; and
determine whether or not the vehicle is considered to have reached a multi-point turning point at a second point on a second path in a case where the first path includes the second path from the first point to the multi-point turning point at which multi-point turning of the vehicle is performed and a third path from the multi-point turning point to the target point; and
in a case where it is determined that the vehicle is considered to have reached the multi-point turning point at the second point, control the driving unit such that the vehicle travels to a position on the third path, the position being away from the second point by a second distance longer than a first distance between the first point and the multi-point turning point.

2. The vehicle control apparatus according to claim 1, wherein the at least one processor is further configured to execute the instructions to determine that the vehicle has reached the multi-point turning point in a case where the vehicle has reached the multi-point turning point and in a case where the multi-point turning point is not reachable by the vehicle.

3. The vehicle control apparatus according to claim 1, wherein the at least one processor is further configured to execute the instructions to determine that the vehicle is considered to have reached the multi-point turning point in a case where a distance between the second point and the multi-point turning point is shorter than a predetermined traversing determination distance.

4. The vehicle control apparatus according to claim 3, wherein the at least one processor is further configured to execute the instructions to change a value of the traversing determination distance to a value larger than a current value in a case where it is determined that the vehicle is considered to have reached the multi-point turning point.

5. The vehicle control apparatus according to claim 3, wherein the at least one processor is further configured to execute the instructions to change a value of the traversing determination distance to a value smaller than a current value in a case where the vehicle has moved to a position away from the multi-point turning point by a predetermined distance.

6. The vehicle control apparatus according to claim 3, wherein the at least one processor is further configured to execute the instructions to;
generate a fourth path obtained by updating the first path in a case where the vehicle has reached a third point, and
change a value of the traversing determination distance to a value smaller than a current value in a case where the fourth path includes a fifth path from the third point to a second multi-point turning point at which multi-point turning of the vehicle is performed and a sixth path from the second multi-point turning point to the target point, and a distance of the fifth path is longer than the traversing determination distance.

7. The vehicle control apparatus according to claim 1, wherein the at least one processor is further configured to execute the instructions to;
control a direction in which the vehicle travels by determining a steering angle, and
determine that the multi-point turning point is not reachable in a case where a time required to rotate from a current steering angle to a steering angle for the vehicle to travel toward the multi-point turning point is longer than a maximum value of a time required for the vehicle to move to the multi-point turning point.

8. A vehicle control method comprising:
generating a first path for a vehicle to move from a first point where the vehicle is present to a target point so as to be in a target orientation at the target point;
determining whether or not the vehicle has reached a multi-point turning point or whether or not the multi-point turning point is reachable by the vehicle in a case where the first path includes the multi-point turning point at which multi-point turning of the vehicle is performed; and
generating a second path for moving the vehicle to a position away from a second point by a second distance longer than a first distance between the first point and the second point in a case where it is determined that the vehicle has reached the multi-point turning point or the multi-point turning point is not reachable by the vehicle at the second point.

9. A non-transitory computer-readable medium storing a program for causing a computer to execute:
generating a first path for a vehicle to move from a first point where the vehicle is present to a target point so as to be in a target orientation at the target point;
determining whether or not the vehicle has reached a multi-point turning point or whether or not the multi-point turning point is reachable by the vehicle in a case where the first path includes the multi-point turning point at which multi-point turning of the vehicle is performed; and
generating a second path for moving the vehicle to a position away from a second point by a second distance longer than a first distance between the first point and the second point in a case where it is determined that the vehicle has reached the multi-point turning point or the multi-point turning point is not reachable by the vehicle at the second point.
